(19) United States
(12) Patent Application Publication
(10) Pub. No.: US 2008/0127254 A1
(43) Pub. Date: May 29, 2008

(54) SUBSCRIBER BASED TV OPERATION

(76) Inventor: Satoshi Nakajima, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/534,335

(22) Filed: Sep. 22, 2006

(51) Int. Cl. H04N 5/00

(52) U.S. Cl. 725/38; 725/37

(57) ABSTRACT

Methods, apparatuses, and articles of manufacture for receiving, by a television set, from a wireless communication device proximally disposed within a communication and viewing distance from the television set, a subscriber identification associated with a subscriber of a wireless communication service provided through the wireless communication device, are described herein. The television set may further determine whether the subscriber is a known user of the television set, having one or more preferences, and operate, including accommodating the user's one or more preferences where possible.

### FIELD OF THE INVENTION

The present invention relates to the field of media content consumption, in particular, to methods and apparatuses for operating a television set to accommodate preferences of a user based on information identifying the user received from a proximally disposed wireless communication device.

### BACKGROUND OF THE INVENTION

Advances in television (TV), multimedia presentation, and digital networking technologies have made possible the increased customization of TV-available contents to suit viewer preferences. Viewers are now able to select packages of TV channels suited to particular interests, to order particular programs at will, and to even record specific programs for viewing at a later time. Such selections, however, require action by a viewer, such as placing an order for a channel-package or a TV program/movie, or directing the TV to record a TV program for later viewing. Such customizations are made on a per-cable TV subscription basis or on a per-TV basis, not on a per-viewer basis. Each channel or program available to one TV viewer is also available to the other viewers, the TV making no distinction between the viewers.

TVs are now also linkable to computer systems, or comprise computer systems themselves, allowing users to login to user accounts established on a given operating system and to use an application of the operating system to view multimedia contents, such as TV channels or programs. Content customizations associated with a particular user login are also available to present a logged-in user with content that may be of interest to the user. Numerous methods of logging into such computer systems are also known, including text or voice input from a user through a peripheral device of the computer system.

In another field of endeavor, advances in cellular and wireless communication device technologies and in wireless networking have enabled wireless communication devices to engage in both cellular and wireless networked communication, enabling both phone calling and Internet accessing. Such wireless communication devices are adapted to provide subscriber information associated with a subscriber of a wireless service.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of various embodiments of the present invention, operating a television set to accommodate preferences of a user based on information identifying the user received from a proximally disposed wireless communication device;

FIG. 2 illustrates a flow chart view of selected operations of the methods of various embodiments of the present invention;

FIG. 3 illustrates a system including a television set and a computer system, the television set and computer system adapted to accommodate preferences of a user based on information identifying the user received from a proximally disposed wireless communication device; and

FIG. 4 is a block diagram illustrating an example television set suitable for use to practice the present invention, in accordance with various embodiments.

### DETAILED DESCRIPTION OF EMBODIMENTS OF THE INVENTION

Illustrative embodiments of the present invention include, but are not limited to, methods and apparatuses for receiving, by a television set, from a wireless communication device proximally disposed within a communication and viewing distance from the television set, a subscriber identification associated with a subscriber of a wireless communication service provided through the wireless communication device. The television set may further determine whether the subscriber is a known user of the television set, having one or more preferences, and operate, including accommodating the user's one or more preferences where possible.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

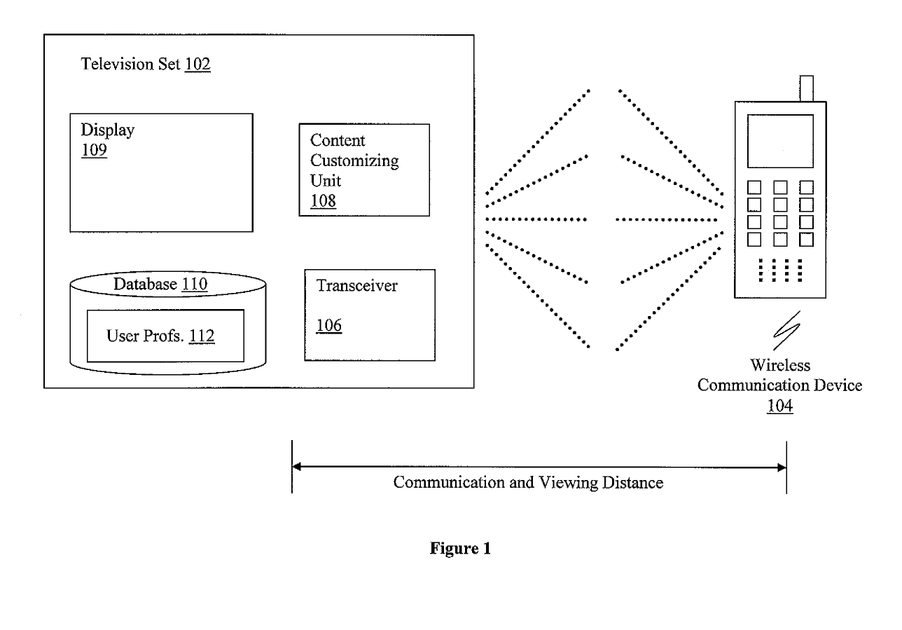

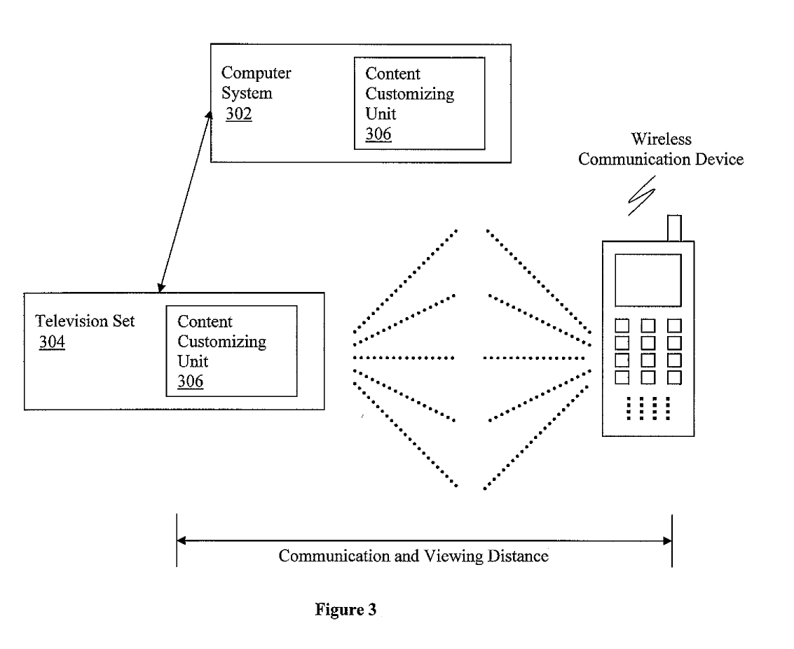

FIG. 1 illustrates an overview of various embodiments of the present invention, operating a television set to accommodate preferences of a user based on information identifying the user received from a wireless communication device. As illustrated, a television set 102 (hereinafter, TV 102) may receive subscriber information from a wireless communication device 104, the subscriber information being associated with a subscriber of a wireless communication service provided through the wireless communication device 104. In some embodiments, the wireless communication device 104 may be located within a communication and viewing distance from the TV 102. Upon receiving the subscriber information, a content customizing unit 108 of TV 102 may determine whether the subscriber is a known user having one or more preferences, and if not, create an account for the user. The content customizing unit 108 may then further operate TV 102, rendering content on display 109, including accommodating the determined preferences and learning user preferences through viewing inputs to TV 102. In one embodiment, illustrated in FIG. 3 and discussed in detail below, all or a portion of content customizing unit 108 may be located on a computer system physically coupled to TV 102 through a cable or connected to TV 102 via a networking fabric.

As is further illustrated, TV 102 may also comprise a transceiver 106 adapted to communicate with and/or receive communications from a wireless communication device 104, and a database 110, the database 110 being capable of storing one or more user profiles 112 associated with users known to TV 102.

In various embodiments, TV 102, except for transceiver 106, content customizing unit 108, and database 110, may be any sort of TV known in the art. TV 102 may receive analog or digital audiovisual signals through an attached cable, such as a serial connector, a parallel connector, a USB connector, or an IEEE 1394 high performance serial bus, or through wireless means, either using optical technologies, such as an Infrared Data Association (IrDA) standard based optical connection, or using WiFi technologies, such as Bluetooth or IEEE 802.11 based electro-magnetic wireless connections. Also or instead, TV 102 may receive UHF- or VHF-band transmissions via an antenna. In addition to the audiovisual signals, TV 102 may further receive data transmissions through the same or a different cable/wireless means. For example, audiovisual signals may be received through an analog or digital cable, and data transmissions may be received through an Ethernet connection. TV 102 may then also be equipped to receive one more types of connectors, such as Coaxial connectors, component video connectors, S-Video connectors, and Ethernet connectors, among may others known in the art. In addition to receiving connectors for audiovisual signals and data transmissions, TV 102 may also be adapted to receive connectors from peripheral apparatuses such as DVD players, VCRs, and video game consoles, among many others.

To render images, TV 102 may also make use of any display known in the art for display 109, such as a CRT display, projection display, flat-panel LCD display, or plasma display. For outputting audio signals, TV 102 may include one or more speakers (not shown), which may be stereo speakers or any other sort of speakers known in the art, and may use any format known in the art, such as the NICAM format. In various embodiments, TV 102 may also include a processor, system memory, mass storage, GPIO, and a video adapter, such as those illustrated by FIG. 3 and described in further detail below.

In other embodiments, TV 102 may serve as a controllee apparatus capable of generating interface displays, such as user interfaces enabling channel selection, and may provide such user interface displays to a remote control or similar device. The displays may include associated commands to be transmitted to TV 102 upon interaction with the user interface display through the remote control, whereupon TV 102 may perform operations in accordance with the received commands. Such user interface displays may constitute, for example, graphic numbered buttons to enable channel selection and graphic arrow keys to enable channel browsing. These interfaces may be displayed, for example, on a touch sensitive display of the remote control. Such a controllee apparatus is the subject of recently issued U.S. Pat. No. 7,095,456, entitled “Field Extensible Controllee Sourced Universal Remote Control Method and Apparatus,” and issued Aug. 22, 2006, that patent fully incorporated herein by reference.

As is further shown, wireless communication device 104 may be any sort of wireless device known in the art capable of cellular and/or wireless data communications. Wireless communication device 104 may be, for example, a mobile phone, a personal digital assistant (PDA), or a portable game console. Wireless communication device 104 may include a memory device capable of storing subscriber information associated with a subscriber of a wireless communication service provided through wireless communication device 104. Such subscriber information may comprise, for example, a number uniquely identifying a subscriber, or a subscriber name and phone number. The wireless communication device 104 may also include one or more communication means known in the art, such as a wireless networking interface capable of sending and receiving wireless data communications, a cellular communication means capable of making, receiving, and maintaining a cellular phone call, and messaging service means capable of sending and receiving text and/or visual messages. In addition to the one or more communication means, wireless communication device 104 may also include a number of other components, such as a display means, alphanumeric and browsing/selection input means, audio input/output means, a processor, an LED, a tuner, a power supply, such as a battery, and a protective casing, each of any sort known in the art.

The subscriber information stored on wireless communication device 104 may be for any sort of wireless communication service associated with wireless communication device 104. In one embodiment, wireless communication device 104 may be associated with a specific wireless communication service provider, and may offer one or more of cellular, messaging, and ISP services to a user/subscriber through the user's wireless communication device 104.

In various embodiments, logic of wireless communication device 104 may periodically broadcast discovery packets to discover presence of TV, such as TV 102, within a communication distance of wireless communication device 102. Wireless communication device 104 may then receive response packets from TV 102 indicating receipt of the discovery packet and indicating a network address of TV 102, and may in turn send TV 102 the subscriber information, using the network address. In another embodiment, wireless communication device 104 may simply receive discovery packets from TV 102, including a network address of TV 102, and in return send TV 102 the subscriber information, using the network address. The sending of discovery packets and/or subscriber information, and the receiving of discovery and/or response packet by wireless communication device 104 may be accomplished by the above described wireless means, including for example, optical wireless means, such as an Infrared Data Association (IrDA), or using WiFi means, such as Bluetooth or IEEE 802.11.

In some embodiments, upon wirelessly receiving a discovery packet from TV 102, wireless communication device 104 may call TV 102 using the above mentioned cellular means or Internet data connection means (i.e., using Voice Over IP (VOIP), and may provide the subscriber information to TV 102 through the call. The phone number of TV 102 may be included in the discovery packet. In one embodiment, TV 102 may not send a discovery packet, and the call to TV 102 may instead be initiated by the user making use of the various above described input means to call TV 102, or may be initiated in response to a certain trigger, such as a time of day, by logic of wireless communication device 104. Such calls may also provide the subscriber information.

In yet other embodiments, wireless communication device 104 may send subscriber information to TV 102 using messaging service means, such as short messaging service (SMS) means capable of sending SMS messages, and/or multimedia message service means capable of sending MMS messages. Wireless communication device 104 may do this in response to receipt of a discovery packet from TV 102, the packet providing a return phone number/address for the receipt of messages by TV 102, or in response to input by the wireless communication device 104 user, or in response to logic of wireless communication device 104 initiating the message.

In various other embodiments, wireless communication device 104 may serve as a remote control capable of receiving user interface displays from a controllee apparatus, such as TV 102, the user interfaces enabling channel selection, may display the user interface displays to a user to receive selections from the user, and may, in response, provide commands associated with the selections to TV 102. Such user interface displays may constitute, for example, graphic numbered buttons to enable channel selection and graphic arrow keys to enable channel browsing. These interfaces may be displayed, for example, on a touch sensitive display of wireless communication device 104, in embodiments where wireless communication device 104 has such a touch sensitive display. Such a remote control is the subject of the recently issued U.S. Patent entitled “Field Extensible Controllee Sourced Universal Remote Control Method and Apparatus,” the citation and incorporation of which is provided above.

In such embodiments, where the wireless communication device 104 is adapted to act as a remote control for TV 102, performing at least one of sending a command to powering TV 102 on or off, or sending a command to change the current channel of TV 102 to a different channel, the wireless communication device 104 may transmit the subscriber information to TV 102 in association with the transmission of a command. For example, if a user of the wireless communication device 104 should initiate a change channel command, subscriber information may be provided to TV 102 along with the command. In one embodiment, the subscriber information may comprise header information of a command.

As illustrated, TV 102 and wireless communication device 104 may be disposed within a communication and viewing distance of each other. The above described wireless communication device 104 may possess a communication distance representing a maximum distance that the wireless communication device 104 is capable of broadcasting/sending discovery packets and/or subscriber information. TV 102 may likewise possess a communication distance representing a maximum distance that the TV 102 is capable of broadcasting responses to discovery packets and/or discovery packets. TV 102 may also have a viewing distance capable of being calculated by logic of TV 102. Such logic may be the content customizing unit 108 or other logic of TV 102. The viewing distance may be, in some embodiments, a function of the size of the display of TV 102. If the viewing distance is calculated to be less than the communication distance of TV 102, TV 102 may, for example, reduce the power available to transceiver 106 when transceiver 106 is broadcasting discovery packets and/or response packets, thus adjusting the communication distance of TV 102 to be no more than the calculated viewing distance. If wireless communication device 104 is beyond the communication distance or adjusted communication distance of TV 102, no content customizing may occur. If TV 102 is beyond the communication distance of wireless communication device 104, no content customizing may occur. Thus, the communication and viewing distance may be no more than the smallest of the communication distances, adjusted or otherwise, of TV 102 and wireless communication device 104. In other embodiments, not shown, no viewing distance is calculated or adjusted for by TV 102. In such embodiments, the communication distance may be the smaller of the communication distances of TV 102 and wireless communication device 104.

In various embodiments, the transceiver 106 of TV 102 may be any of wireless, optical, wired, and/or telephony/messaging means to send communications to and receive communications from wireless communication device 104. In one embodiment, transceiver 106 may comprise wireless and/or optical means of TV 102 and be adapted to broadcast discovery packets, including a network address of TV 102. Transceiver 106, comprising the wireless and/or optical means, may also be adapted to receive discovery packets from wireless communication device 104, and may be adapted to send a response packet, including a network address of TV 102. In addition to receiving discovery packets, transceiver 106, comprising the wireless and/or optical means, may also receive subscriber information, the subscriber information sent by the wireless communication device 104 in response to discovery or response packets.

In other embodiments, transceiver 106 may instead comprise telephony/messaging means capable of receiving phone calls and/or SMS/MMS messages from wireless communication device 104. Transceiver 106 may thus receive subscriber information from wireless communication device 104 through a phone call or an SMS/MMS message in such embodiments. In one embodiment, transceiver 106 may comprise both wireless/optical and telephony/messaging means, and may broadcast discovery packets through the wireless/optical means, and may receive subscriber information in response to the discovery packets through telephony/messaging means. In embodiments wherein transceiver 106 comprises telephony/messaging means, TV 102 may also have a phone number callable by the wireless communication device 104. The phone number may be included along with or in place of the above network address in the broadcast discovery packets, allowing wireless communication device 104 to respond through wireless/optical means or through a call/message. In a further embodiment, transceiver 106 may receive a phone number of the wireless communication device 104, through, for instance, a discovery packet sent by wireless communication device 104 and, comprising at least telephony messaging means, may send a response call/message to wireless communication device 104 indicating receipt of the discovery packet.

In some embodiments, transceiver 106 may receive subscriber information at wireless communication device 104's initiation, without any exchange of discovery packets.

In yet another embodiment, transceiver 106 may comprise a wired interface of TV 102, such as those described above, and may send discovery/response packets and/or receive discovery packets/subscriber information. As a wired interface, transceiver 106 may, in turn, be locally coupled to another device having wireless, optical, and/or telephony/messaging means of the sort described above, capable of sending packets, making calls/messages, receiving packets, and/or receiving calls/messages from wireless communication device 104. In yet another embodiment, transceiver 106 may be coupled to a router having networking connectivity to a LAN or a WAN, wherein another device of the LAN or WAN has wireless, optical, and/or telephony/messaging means of the sort described above, capable of sending packets, making calls/messages, receiving packets, and/or receiving calls/messages from wireless communication device 104.

In some embodiments, wherein wireless communication device 104 is a remote control of TV 102, the subscriber information may be sent in association with a command to TV 102 transmitted by wireless communication device 104.

As is shown, content customizing unit 108 of TV 102 may comprise logic coupled to transceiver 106 and adapted to receive subscriber information, determine whether the subscriber information corresponds to a know user, and if so, determine whether that user has preferences, and to operate TV 102 to accommodate such preferences where possible. In some embodiments, content customizing unit 108 may be adapted to direct the above described sending and receiving operations of the transceiver 106. The content customizing unit 108 may periodically request the transceiver to broadcast discovery packets and to respond to wireless communication device 104 discovery packets when received by transceiver 106. In addition, transceiver 106 may notify content customizing unit 108 any time a discovery packet or subscriber information is received. In one embodiment, wherein transceiver 106 comprises both wireless and telephony means, content customizing unit 108 may determine whether to send a response packet via the wireless means or via a phone call, upon notification that a discovery packet has been received.

In various embodiments, upon receiving the subscriber information, content customizing unit 108 may determine whether the subscriber information identifies a known user. To make this determination, content customizing unit 108 may query database 110 for any user profiles 112 stored in the database 110 corresponding to the subscriber information. If such a user profile exists, database 110 may return the user profile 112 to content customizing unit 108 as a query result. If such a profile 112 does not exist, database 110 may return a null set. If content customizing unit 108 receives a null set result to the query, content customizing unit 108 may direct the database 112 to create a new, empty user profile 112. If, on the other hand, the subscriber information corresponds to a user profile 112, the query result returned by database 110 may include a list of one or more preferences.

Upon receiving a query result including one or more preferences, content customizing unit 108 may operate TV 102 to accommodate the preferences where possible. In operating TV 102, content customizing unit 108 may accommodate the user preferences in many different ways. For example, if TV 102 has a digital cable television service providing television programs and content, content customizing unit 108 may request commercials from the service having some association with the user preference. Thus, if the preferences indicate that a user likes sports and a certain television program, commercials for sporting goods and the television program may be provided. In other embodiments, the cable service may provide a list of currently broadcasting television programs and commercials, and the content customizing unit 108 may select a program or commercial based on the user preferences and tune the TV 102 channel to that program or commercial. In yet other embodiments, content customizing unit 108 may generate a television guide to present to the user based on the user's preferences. The content customizing unit 108 may generate such a guide by applying the preferences as a filter to a comprehensive guide provided by the cable service. In addition to selecting commercials based on user preferences, making a channel selection based on the preferences, and creating a television guide based on the preferences, content customizing unit 108 may operate TV 102 to accommodate the determined preferences in any other number of ways.

In some embodiments, in addition to operating TV 102 to accommodate user preferences, content customizing unit 108 may learn user preferences through a user's television viewing behavior. To learn the preferences, content customizing unit 108 may make use of any sort of learning algorithm known in the art. A given “item” of viewing behavior (e.g., browsing from one channel to another, watching a program for its duration, watching a large number of programs from one channel or in one subject area (e.g., news), etc.) may be associated with the most recently received subscriber information, unless such information was received prior to the last TV 102 power off event. Upon determining a new preference, through application of the learning algorithm, content customizing unit 108 may write the preference to the user profile associated with the most recently received subscriber information. Such new preferences can be added to a newly established, empty profile or to a well established profile.

In various embodiments, after determining that a user profile associated with recently received subscriber information exists, but before operating the TV 102 to accommodate the preferences stored in the user profile, content customizing unit 108 may determine whether it is already operating TV 102 to accommodate preferences associated with previously received subscriber information. If it is, content customizing unit 108 may determine whether to switch to operate the TV 102 to accommodate the user preferences associated with the newly received subscriber information, to continue to operate TV 102 to accommodate the user preferences associated with the previously received user preferences, or to operate TV 102 to accommodate both sets of user preferences, or at least a subset comprising the non-conflicting preferences. To make the determination, content customizing unit 108 may, for example, query the user profiles 112 of database 110 for a user priority assigned to each of the user profiles 112, and operate to accommodate the preferences of the highest priority user, unless both are the same, in which case both may be accommodated. In other embodiments, content customizing unit 108 may simply utilize a default rule, such as “operate to accommodate most recent” or “operate to accommodate least recent” or “operate to accommodate both.” Content customizing unit 108 may also resolve conflicting preferences, if content customizing unit 108 determines to operate TV 102 to accommodate both sets of preferences. For example, if each set of preferences includes a different favorite show, but the shows air at the same time, content customizing unit 108 may ignore the preferences. If user profiles 112 include weights indicating the importance of preferences, then content customizing unit 108 may determine the one of the conflicting preferences with the higher weight, and operate to accommodate that preference.

As is shown, database 110 may include user profiles 112 and may be locally disposed on TV 102. Database 110 may be any sort of database known in the art, such as a relational database, and may be normalized or de-normalized. Also, database 110 may include any number of tables/records to store data, such as user profiles 112. Further, database 110 may be responsive to queries and create/delete commands received from other processes, such as content customizing unit 108. In other embodiments, not shown, database 110 may be located on a remote system, also not shown, rather than being locally disposed. In such embodiments, the remote system and TV 102 may engage in networked communication using one or more of the communication interfaces of TV 102 described above and below. Such a remote system may be a database server.

In some embodiments, user profiles 112 may comprise tables/records of database 110. The user profiles 112 may include a plurality of rows/fields. One field may designate a unique identifier of a user profile 112, which may correspond to subscriber information. Other fields may store one or more user preferences, and may also store weights associated with each preference to indicate a level of importance. In addition, another field may store a user priority code indicating the importance of a specific user. The user preferences stored in the user profile 112 may be any sort of indicator related to the consumption of television content, such as the name of a most frequently viewed television program, a category of programs most frequently viewed, such as news or sports, a most frequently viewed television channel, etc.

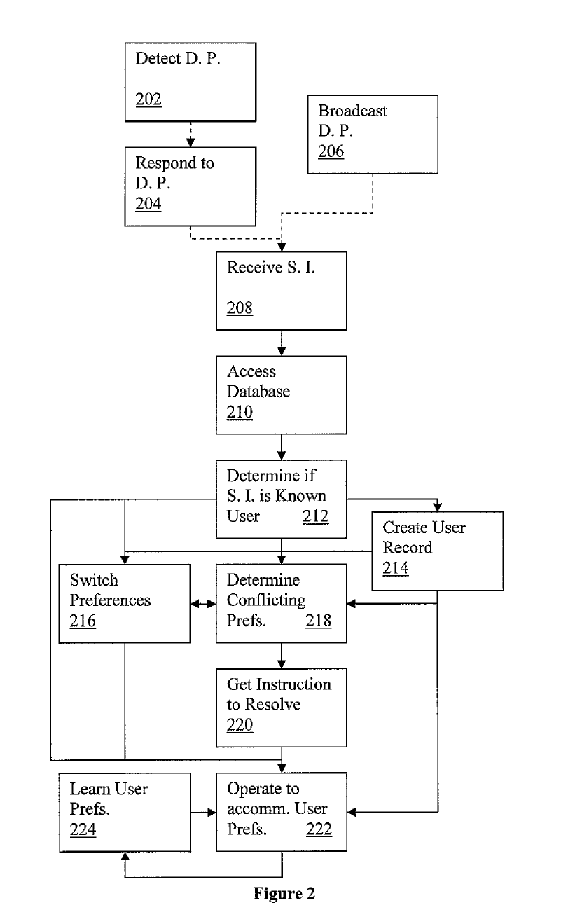

FIG. 2 illustrates a flow chart view of selected operations of the methods of various embodiments of the present invention. As illustrated, a television set (TV) having a content customizing unit and a transceiver may receive subscriber information from a wireless communication device, block 208, in some embodiments, in response to an exchange of discovery packets, blocks 202-206. In a first embodiment, the TV may receive, through its transceiver, a discovery packet broadcast by a wireless communication device, which may be disposed within a communication and viewing distance from the TV, block 202. The discovery packet may include a phone number and/or network address of the wireless communication device. The TV may then send a response packet or call to the wireless communication device through the TV's transceiver, block 204. In a second embodiment, the TV may broadcast, through its transceiver, a discovery packet, which may be received by a wireless communication device disposed within a communication and viewing distance from the TV, block 206. The discovery packet may include a phone number and/or network address of the TV. In both first and second embodiments, the wireless communication device may then provide the TV with subscriber information, block 208, the subscriber information being associated with a user of the wireless communication device, the user being a subscriber of wireless communication services. In the first embodiment, the subscriber information may be provided by the wireless communication device in response to receipt by the wireless communication device of the response packet/call. In the second embodiment, the subscriber information may be provided by the wireless communication device in response to receipt by the wireless communication device of the discovery packet. In a third embodiment, wireless communication device may send/broadcast the subscriber information at the instigation of its logic or at a user's instigation, without any prior exchange of packets/calls.

Upon receipt of the subscriber information, the content customizing unit of the TV may access a local or remote database to determine whether the subscriber information is associated with a known user, block 210. The content customizing unit may use the subscriber information as a query parameter to look up user profiles stored as records in the database, the records identified by the subscriber information. The database may then return user profiles having the subscriber information, if any, as a query result. If there are no matching profiles, the database may return a null set. Upon receiving the query result, the content customizing unit may determine if the subscriber information corresponds to a known user (i.e., whether the results comprise a null set), block 212. If the results comprise a null set, indicating that the user is not known, the content customizing unit may direct the database to create an empty user profile/record to be identified by and to include the subscriber information, block 214.

In various embodiments, the content customizing unit may then determine whether it has been operating the TV to accommodate preferences of a user associated with previously received subscriber information, and if so, whether to switch to instead operate the TV to accommodate the preferences of a user associated with the newly received subscriber information, block 216. The content customizing unit may determine to switch, to not switch, or may instead determine to operate the TV to accommodate the preferences of both users, or at least the non-conflicting preferences. If operating the TV to accommodate the union of preferences, the content customizing unit may then determine whether there are conflicting preferences, block 218, and if so, retrieve an instruction to resolve the conflicting preferences, block 220.

As is shown, the content customizing unit may next operate the TV to accommodate the user preferences, where possible, block 222. The user preferences may include the name of a favorite show, a frequently viewed channel, a frequently viewed category of television program/commercial, etc. The TV may have a digital cable television service offering TV programs and content, and the content customizing unit may request commercials or programs corresponding to the preference. The content customizing unit may also or instead receive a list from the service of all currently broadcasting programs and commercials, and in response select a program or commercial corresponding to the preferences. Further, the content customizing unit may also or instead receive a comprehensive TV program guide, and may apply to preferences as a filter to the guide to generate a targeted program guide including programs associated with the user preferences. The content customizing unit may also or instead operate the TV to accommodate user preferences in any number of other ways.

In various embodiments, the content customizing unit may also include a learning algorithm capable of learning the user preferences based on viewing behavior of the user, block 224. Such viewing behavior may include channel selection, the viewing of an entire program, etc. Upon determining a new user preference, the content customizing unit may store the preference in the user profile associated with the most recently received subscriber information.

FIG. 3 illustrates a system including a television set and a computer system, the television set and computer system adapted to accommodate preferences of a user based on information identifying the user received from a proximally disposed wireless communication device. As illustrated, the system includes a computer system 302, a television set 304, and a content customizing unit 306, coupled to each other as shown. Television set 304 and content customizing unit 306 are described in greater detail above in reference to FIG. 1. As is shown, portions of the content customizing unit 306 may be distributed between the computer system 302 and the television set 304, with a first portion residing on the one and a second portion residing on the other. In another embodiment (not shown), content customizing unit 306 may reside entirely on computer system 302.

In various embodiments, computer system 302 is a selected one of a set-top box and a server. If a set-top box, computer system 302 may be locally, physically coupled to television set 304, either directly through a cable or indirectly through a plurality of cables and an intermediary device capable of relaying signals. If, on the other hand, computer system 302 is a server remotely coupled to television set 304 via a networking fabric, computer system 302 may be any sort of server system known in the art. The networking fabric connecting computer system 302 to television set 304 may be any one or more of a local area network, a wide area network, and the Internet (portions of which may be wired and/or wireless). The computer system 302 and the television set 304 may also use any sort of communication protocol known in the art, such as the Hypertext Transfer Protocol (HTTP), and any sort of transport protocol known in the art, such as the Transmission Control Protocol/Internet Protocol (TCP/IP) suite of protocols.

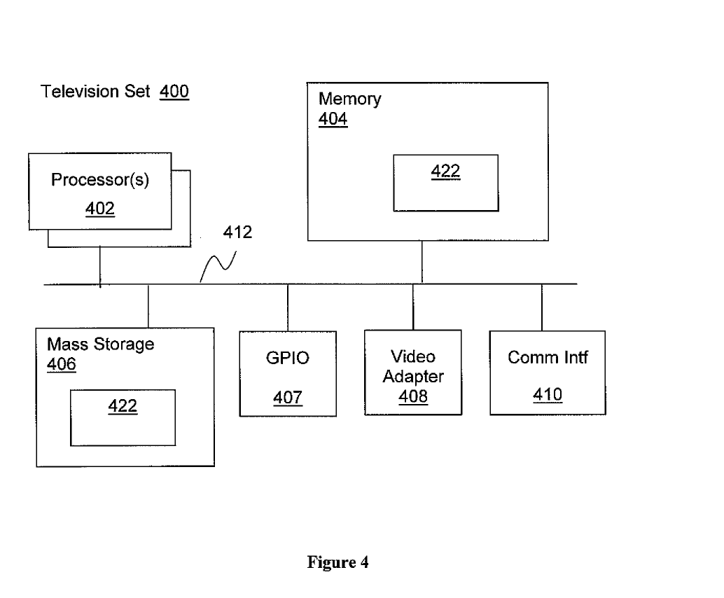

FIG. 4 is a block diagram illustrating an internal component view of an example television set suitable for use to practice the present invention, in accordance with various embodiments. As shown, television set 400 includes one or more processors 402 and system memory 404. Additionally, television set 400 includes mass storage devices 406 (such as diskette, hard drive, CDROM and so forth), GPIO 407, video adapter 408, and communication interfaces 410 (such as serial, parallel, USB, or IEEE 1394 based wired interfaces, Bluetooth/IEEE 802.11 based wireless interfaces, and/or IrDA standard based optical interfaces), including transceiver 106 and a tuner. The elements are coupled to each other via system bus 412, which represents one or more buses. In the case of multiple buses, they are bridged by one or more bus bridges (not shown).

Each of these elements performs its conventional functions known in the art. In particular, system memory 404 and mass storage 406 may be employed to store a working copy and a permanent copy of the programming instructions implementing selected ones or all of the various components of embodiments of the present invention, such as the processes illustrated by FIG. 1, herein collectively denoted as 422. The various components may be implemented as assembler instructions supported by processor(s) 402 or high-level languages, such as C, that can be compiled into such instructions.

The permanent copy of the programming instructions may be placed into permanent storage 406 in the factory or in the field, through, for example, a distribution medium (not shown) or through communication interface 410 (from a distribution server (not shown)).

The constitution of these elements 402-412 is known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. Those skilled in the art will readily appreciate that the present invention may be implemented in a very wide variety of embodiments or extended therefrom. This application is intended to cover any adaptations or variations of the embodiments discussed herein. Therefore, it is manifestly intended that this invention be limited only by the claims and the equivalents thereof.

What is claimed is:

1. A method comprising:
receiving, by a television set, from a wireless communication device proximally disposed within a communication and viewing distance from the television set, a subscriber identification associated with a subscriber of a wireless communication service provided through the wireless communication device;
determining whether the subscriber is a known user of the television set, having one or more preferences; and
operating the television set, including accommodating the user's one or more preferences where possible.

2. The method of claim 1, wherein the television set is wireless communication capable, and the method further comprises periodically broadcasting one or more discovery packets by the television set to determine whether any wireless communication device capable of communicating with the television set is proximally located, the subscriber identification being provided by the wireless communication device after receiving one of the discovery packets.

3. The method of claim 1, wherein the television set is wireless communication capable, and the method further comprises detecting, by the television set, a discovery packet transmitted by the wireless communication device and responding, by the television set, to the detected discovery packet, the subscriber identification being provided by the wireless communication device after receiving the response from the television set to the discovery packet.

4. The method of claim 1, wherein the television set is telephony capable and has an associated phone number, and the receiving comprises receiving the subscriber identification by the television set through a call to the television set from the wireless communication device.

5. The method of claim 1, wherein the television set is telephony and message service (MS) capable and has an associated phone number, and the receiving comprises receiving by the television set a short or multimedia message comprising the subscriber identification from the wireless communication device.

6. The method of claim 1, wherein the television set is network capable and has an associated network address, and the receiving comprises receiving by the television set a packet comprising the subscriber identification, addressed to the television set, transmitted from the wireless communication device.

7. The method of claim 1, wherein the wireless communication device is adapted to perform at least one of commanding the television set to power on/off and commanding the television set to change a current channel to a different channel, and the receiving comprises receiving, by the television set, the subscriber identification as information associated with a power on/off command and/or a change channel command transmitted from the wireless communication device.

8. The method of claim 1, wherein said determining whether the subscriber is a known user comprises accessing a database of user records to determine whether a user record has been previously created for the subscriber.

9. The method of claim 8, wherein the database is locally disposed on the television set.

10. The method of claim 1, wherein said operating comprises creating a user record for the user, if the subscriber is determined not to be a known user of the television set, and learning the user's preferences.

11. The method of claim 1, wherein said operating comprises determining whether the television set is currently operating in accordance with another user's preferences, and if the television set is currently operating in accordance with another user's preferences, asking for instructions on whether the television is to continue to operate with the other user's preference, switching to the user's preference, or operating in accordance with a union of the users' non-conflicting preferences.

12. The method of claim 11, further comprising determining whether there are conflicting preferences, and asking for instructions to resolve conflicting preferences, if there are conflicting preferences, when instructed to operate in accordance with a union of the users' non-conflicting preferences.

13. The method of claim 1, wherein said operating comprises operating the television set with at least a programming guide tailored to the user's preferences.

14. A television set comprising:
a processor;
a transceiver coupled to the processor; and
a content customizing unit operated by the processor and adapted to
receive, from a wireless communication device proximally disposed within a communication and viewing distance from the television set, a subscriber identification associated with a subscriber of a wireless communication service provided through the wireless communication device,
determine whether the subscriber is a known user of the television set, having one or more preferences, and
operate the television set, including accommodating the user's one or more preferences where possible.

15. The television set of claim 14, wherein the wireless communication device is a selected one of a mobile phone, a PDA, and a portable game console.

16. The television set of claim 14, wherein the transceiver is a wireless transceiver, and the content customizing unit is further adapted to periodically broadcast one or more discovery packets to determine whether any wireless communication device capable of communicating with the television set is proximally located, the subscriber identification being provided by the wireless communication device after receiving one of the discovery packets.

17. The television set of claim 14, wherein the transceiver is a wireless transceiver, and the content customizing unit is further adapted to detect a discovery packet transmitted by the wireless communication device and respond to the detected discovery packet, the subscriber identification being provided by the wireless communication device after receiving the response from the television set to the discovery packet.

18. The television set of claim 14, wherein the transceiver is telephony capable and has an associated phone number, and the content customizing unit is further adapted to perform said receiving, wherein said receiving comprises receiving the subscriber identification through a call to the television set from the wireless communication device.

19. The television set of claim 14, wherein the content customizing unit is further adapted to perform said determining by accessing a database of user records to determine whether a user record has been previously created for the subscriber.

20. The television set of claim 14, wherein the content customizing unit is further adapted to create a user record for the user, if the subscriber is determined not to be a known user of the television set, and to learn the user's preferences.

21. The television set of claim 14, wherein the content customizing unit is further adapted to perform as part of said operating, determining whether the television set is currently operating in accordance with another user's preferences, and if the television set is currently operating in accordance with another user's preferences, asking for instructions on whether the television is to continue to operate with the other user's preference, switching to the user's preference, or operating in accordance with a union of the users' non-conflicting preferences.

22. An article of manufacture comprising:
a storage medium; and
a plurality of programming instructions stored on the storage medium and adapted to implement a content customizing unit on a television set to
receive, from a wireless communication device proximally disposed within a communication and viewing distance from the television set, a subscriber identification associated with a subscriber of a wireless communication service provided through the wireless communication device,
determine whether the subscriber is a known user of the television set, having one or more preferences, and
operate the television set, including accommodating the user's one or more preferences where possible.

23. The article of claim 22, wherein the television set is wireless communication capable, and the plurality of programming instructions are to further implement the content customizing unit on the television set to periodically broadcast one or more discovery packets to determine whether any wireless communication device capable of communicating with the television set is proximally located, the subscriber identification being provided by the wireless communication device after receiving one of the discovery packets.

24. The article of claim 22, wherein the television set is wireless communication capable, and the plurality of programming instructions are to further implement the content customizing unit on the television set to detect a discovery packet transmitted by the wireless communication device and respond to the detected discovery packet, the subscriber identification being provided by the wireless communication device after receiving the response from the television set to the discovery packet.

25. The article of claim 22, wherein the plurality of programming instructions are to further implement the content customizing unit on the television set to perform said determining by accessing a database of user records to determine whether a user record has been previously created for the subscriber.

26. The article of claim 22, wherein the plurality of programming instructions are further adapted to implement the content customizing unit on the television set to create a user record for the user, if the subscriber is determined not to be a known user of the television set, and to learn the user's preferences.

27. A system comprising:
a component including a first portion of a content customizing unit; and
a television set coupled to the component, the television set including a second portion of the content customizing unit, wherein the first and second portions of the content customizing are collectively adapted to
receive, from a wireless communication device proximally disposed within a communication and viewing distance from at least one of the computer system and the television set, a subscriber identification associated with a subscriber of a wireless communication service provided through the wireless communication device,
determine whether the subscriber is a known user of the television set, having one or more preferences, and
operate the television set, including accommodating the user's one or more preferences where possible.

28. The system of claim 27, wherein the component is set-top box physically and locally coupled o the television set.

29. The system of claim 27, wherein the component is a server, remotely disposed and coupled to the television set via one or more networks.
